(19) United States
(12) Patent Application Publication
(10) Pub. No.: US 2006/0004849 A1
(43) Pub. Date: Jan. 5, 2006

(54) Simplified anti-collision method for detecting electronic identification devices

(75) Inventor: Riad Kanan, Marin (CH)

Correspondence Address: SUGHRUE MION, PLLC, 2100 PENNSYLVANIA AVENUE, N.W., SUITE 800, WASHINGTON, DC, 20037, US

(73) Assignee: EM MICROELECTRONIC-MARIN SA

(21) Appl. No.: 11/148,412

(22) Filed: Jun. 9, 2005

(30) Foreign Application Priority Data
Jun. 14, 2004 (EP) 04102701.2

(51) Int. Cl. G06F 17/00

(52) U.S. Cl. 707/103 R

(57) ABSTRACT

The invention concerns a simplified anti-collision method applied to a determined assortment of objects of different natures or types, regrouped in the form of a set, each of said objects forming the set being fitted with an electronic identification device including programmable storage means into which there has been programmed an object identifier (DEVICE_ID), which identifies the nature or the type of the object to which the electronic identification device is applied and which is identical to the object identifier of the objects of the same nature or same type placed in other sets, the method including, after the objects have been regrouped to form the set, the following step: selective addressing of each of the objects forming the set by means of object identifiers (DEVICE_ID) of each of the objects forming the determined assortment.

This application claims priority from European Patent Application No. 04102701.2 filed Jun. 14, 2004, the entire disclosure of which is incorporated herein by reference.

### FIELD OF THE INVENTION

The present invention generally concerns a method for managing and following up the manufacturing and packaging process of objects of various natures or types. The invention concerns more particularly a simplified anti-collision method applied to an assembly regrouping a determined assortment of objects of various natures or types.

### BACKGROUND OF THE INVENTION

There is known a method of following up the manufacturing and packaging process of objects of various natures or types by applying an electronic identification device to each of the objects, for example a radio-frequency transponder, comprising programmable storage means, shown in the form of a table in FIG. 1, into which a universal identifier (UID) is programmed, applied by the manufacturer of the electronic identification device. The universal identifier is unique and cannot be modified (Read_Only), which enables each electronic identification device to be identified and followed up in a certain manner.

However, the universal identifier (UID), by its non-modifiable nature, proves restrictive, depending upon the management and follow-up process that is required to be implemented. In fact, it is not possible to modify the universal identifier (UID) so as to register data relating to the object to which the electronic identification device is applied, like for example the manufacturer's name, the place of manufacture or even the date of manufacture of the object.

Allocating a modifiable space (Read_Write), is also known, reserved for the manufacturer, in the programmable storage means of the electronic identification devices, for containing a manufacturer identifier (MUID) enabling data to be provided about the manufacturer, and also about the place or date of manufacture of the objects to which such electronic identification devices are applied.

However, it has been demonstrated within the scope of the present invention, that when objects of different natures or types are packaged in the form of a set regrouping a determined assortment of such objects, it is difficult and costly in time for managing and following up the various objects forming this set. It is of primordial importance to ensure that a set contains all of the different objects supposed to be grouped together therein. In order to ensure the completeness of the contents of a set when it is packaged, a conventional anti-collision method is generally used. Such an anti-collision method consists in interrogating, by means of a radio-frequency reader, the electronic identification devices capable of being present in the reader's field. The reader thus interrogates then recovers, either all of the universal identifiers (UID), or all of the manufacturer identifiers (MUID) in order to determine whether the set interrogated includes each object that it is supposed to contain. Whatever the type of identifier interrogated, the time for detecting them all, and the time for checking whether each of them actually corresponds to an identifier of an electronic identification device applied to each object of the set, is much too long, which is particularly detrimental to the speed of the packaging method. Moreover, this proves relatively complicated when each object of a different type or nature is manufactured at a different location, or even in a different country, by distinct sub-contractors using manufacturer identifiers that can be of different formats.

### SUMMARY OF THE INVENTION

It is a main object of the present invention to implement a simplified anti-collision method for checking quickly and simply the presence of each constituent object of a determined assortment of objects of different natures or types. For this purpose, a memory space is provided in the programmable storage means of the identification devices applied to the objects forming the set, a memory space into which an object identifier is programmed (DEVICE_ID) which identifies the nature or the type of the object to which the electronic identification device is applied. The first object is achieved by using, after regrouping the objects to form a set, a simplified anti collision method according to claim 1.

This method allows thus to rapidly check the completeness of a set regrouping objects of different natures or types. For this purpose one only needs to check the reception of a response from each object forming the set.

It is another object of the present invention to assure a management and/or a following of such a set regrouping these objects of different natures or types. In order to achieve the goal, a set management and/or follow up value is programmed in the programmable storage means of each electronic identification device applied to each of the different objects of the set.

It is another object of the present invention to identify one set among other sets. For this purpose, a set identifier (PACKAGE_ID) is programmed as the management and/or follow-up value, which identifies the set among other sets.

It is another object of the present invention to exploit the set identifier to allow the objects, which are thus communicating devices provided with a wireless communication interface, to communicate with each other via this interface.

It is another object of the present invention to exploit the set identifier to match different objects, which are thus communicating devices provided with a wireless communication interface, in order for them to communicate via this interface.

According to a particular application, a set is formed of communicating electronic devices, such as wireless computer peripheral units selected from a group including, in particular, a computer keyboard, a computer mouse, a “track-ball”, a “track-pad” a game lever or controller, a “joystick”, a video camera, a portable telephone, a personal digital assistant (PDA), a radio-frequency receiver, or a digital camera, any combination being possible.

According to another aspect of the invention, a manufacturing and packaging management and follow-up method for objects of different natures and types is implemented. The objects are to be packaged and distributed in the form of a set regrouping a determined assortment of said objects, each of the objects being fitted with an electronic identification device including programmable storage means. The method includes a step of programming, in the storage means of each electronic identification device, an object identifier, which identifies the nature or the type of the object to which the electronic identification device is applied and which is identical to the object identifiers of objects of the same nature or of the same type placed in other sets.

### BRIEF DESCRIPTION OF THE DRAWINGS

Other features and advantages of the present invention will appear more clearly upon reading the following detailed description of embodiments of the invention given solely by way of non-limiting example and illustrated by the annexed drawings, in which:

FIG. 1, already mentioned, shows in the form of a table, programmable storage means of an electronic identification device according to the prior art;

FIG. 2 shows in the form of a table, programmable storage means of an electronic identification device according to a preferred embodiment of the invention;

FIG. 3 shows in the form of block-diagrams, an electronic identification device applied to the various objects forming a set;

FIG. 4 shows a diagram illustrating an implementation mode of the simplified anti-collision method between the electronic identification devices of a set according to the invention;

FIG. 5 shows a diagram illustrating an implementation mode of the manufacturing and packaging management and/or follow-up method according to the invention; and

FIG. 6 shows the steps for implementing the manufacturing and packaging management and/or follow-up method according to a particular application of the invention.

### DESCRIPTION OF PARTICULAR EMBODIMENTS

The following description presents by way of example various implementation modes of the simplified anti-collision method applied to a determined set of objects of different natures or types, and of the manufacturing and packaging management and/or follow-up method for the objects of different natures or types.

The objects forming the determined assortment are to be packaged and distributed in the form of a set. An electronic identification device is applied to each of these objects during or at the end of the manufacture thereof. Each electronic identification device comprises programmable storage means.

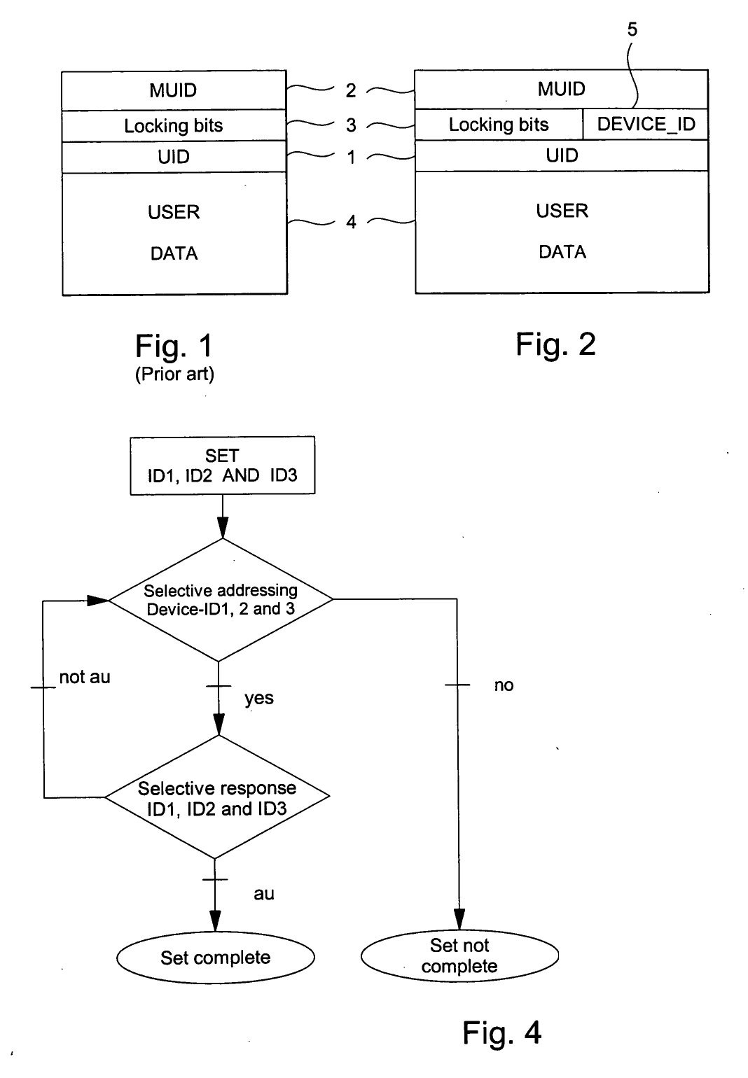

FIGS. 1 and 2 show, in the form of tables, such programmable storage means of an electronic identification device applied to each object of the determined assortment of objects, respectively, according to a solution of the prior art and in accordance with an embodiment of the invention.

These programmable storage means, shown in FIG. 1 according to the prior art, generally include different zones which are detailed hereinafter. A first zone 1 is reserved for containing a universal identifier (UID) programmed by the manufacturer of the electronic identification device. This universal identifier is unique and cannot be modified, i.e. “read-only”. It enables an electronic identification device to be distinguished from any other device. A second zone 2 is reserved for containing a manufacturer identifier (MUID) generally programmed by the object manufacturer, which distinguishes one object manufacturer from another object manufacturer. However, other data concerning, for example, the place or the date of manufacture can also be added in order to allow the objects to which the electronic identification devices are applied, to be followed up. A third zone 3 is also reserved for containing locking bits which guarantee authorised access to the data contained in the storage means, in particular for the read and write operations in the zones reserved for that purpose. Finally, the storage means include a fourth zone 4 which is reserved for the user data, this zone containing the user applications and the data relative to these applications.

FIG. 2 shows storage means of an electronic device according to a preferred embodiment of the invention. There are shown, as in the table of FIG. 1, the first 1, second 2, third 3 and fourth 4 zones reserved respectively for containing the universal identifier (UID) of the electronic identification device, the manufacturer identifier (MUID), the locking bits and the user data.

However, in order to ensure quick and efficient detection of each of the objects forming a set, to which such electronic identification devices are applied, the programmable storage means of the electronic identification devices are provided with a fifth zone 5 comprising an object identifier (DEVICE_ID) for identifying one object type or nature among the other object types or natures present in the set. The number of memory bits reserved in the fifth zone depends upon the number of objects of different types or natures forming a set.

For example, in the case of an assortment formed of a computer mouse, a keyboard and a radio-frequency receiver, the set formed by these three objects includes three types of object, the fifth zone thus having to include at least two bits for encoding these three different object types. In practice, at least one additional bit is provided which leaves the possibility of adding one or several additional object types while using the same memory architecture for the programmable storage means. According to a preferred example, the fifth memory zone includes 4 memory bits, which allows up to 16 different object types to be encoded. The encoding of object types for this example could therefore be as follows:
“0000” for encoding the “computer mouse” type in the storage means of the electronic identification devices applied to the computer mice;
“0001” for encoding the “keyboard” type in the storage means of the electronic identification devices applied to the keyboards; and
“0010” for encoding the “RF receiver” type in the storage means of the electronic identification devices applied to the RF receivers.

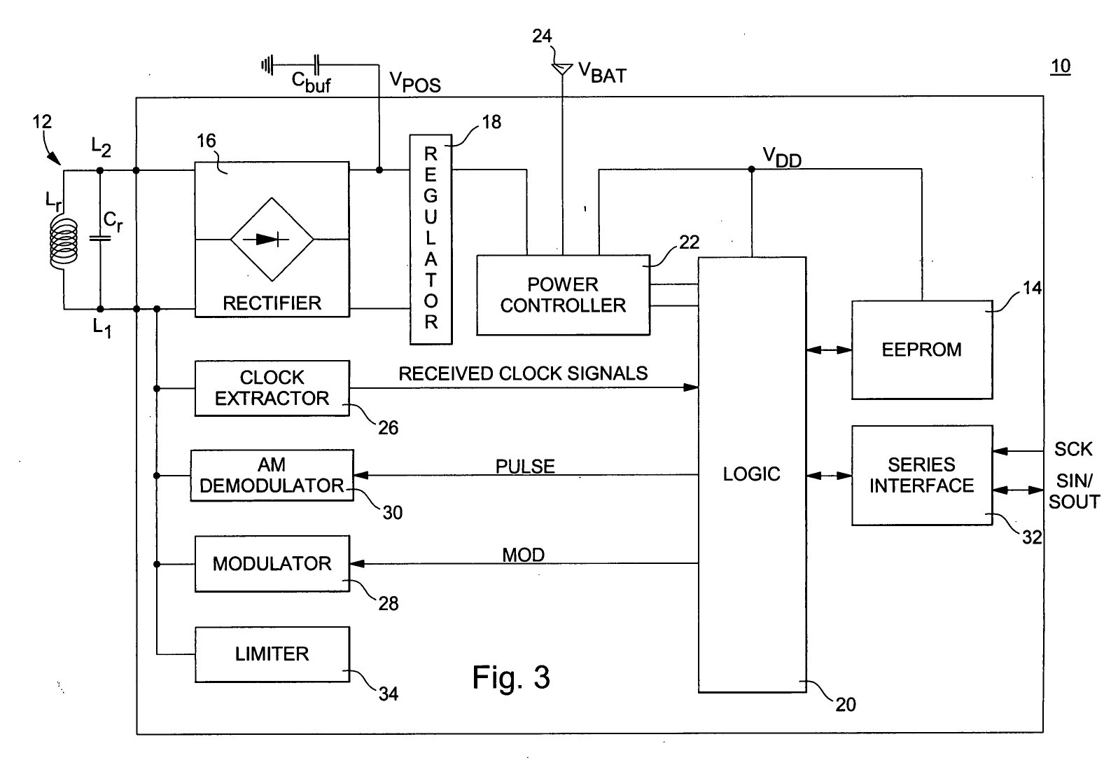

FIG. 3 shows, in the form of block diagrams, an electronic identification device 10 applied to the various objects forming a set. According to this example, the electronic identification device includes a certain number of elements that are detailed hereinafter.

An antenna 12 of the LC type allows signals to be received and transmitted at a given frequency, for example 13.56 MHz. This antenna 12 is used in particular for receiving clock signals at a given frequency, for supplying a supply voltage to electronic identification device 10 if the latter is passive, and for transmitting in response data depending upon the content of storage means 14 of the electronic identification device.

The supply voltage of the electronic identification device, in particular in the case of a device of the passive type, is extracted from the external electromagnetic field by means of a rectifier 16, for example of the bridge rectifier type. Thus, internally, rectifier 16 is connected to the terminals of antenna 12, for converting the signal received at the given frequency into a continuous signal acting as the supply voltage. A regulator 18 is connected to the terminals of rectifier 16 to prevent stress due to surge voltages in the supply voltage, in particular, of logic unit 20. The output of regulator 18 is used for powering most of the logic circuits of electronic identification device 10 including logic unit 20, storage means 14 and most of the analogue input circuits (not detailed here).

A power control circuit 22 is connected to the output of regulator 18. This power control circuit 22 has three functions. The first function is a power-on-reset function, which, depending on the voltage regulated, generates a global reset signal placing electronic identification device 10 in a suitable initial state when it is switched on. This function also guarantees that the electronic identification devices stops functioning when the supply voltage becomes lower than a predetermined threshold necessary for the device to operate reliably. A double threshold is preferably provided, of the hysteresis type, to prevent any improper operation of the device for a supply voltage close to the minimum necessary voltage (repetitive power on, power off).

The second function is a power check function for ensuring, during a write or erase procedure, that the available supply voltage is sufficient prior to carrying out any command intended to modify the content of storage means 14 of the electronic identification device. This power check is carried out prior to the effective start of the programming sequences of storage means 14. This assumes that the force of the external electromagnetic field remains sufficiently large to avoid execution of the command being disturbed during the time required for such programming. A voltage drop below a predetermined limit threshold due to a weakening in the electromagnetic field will not be indicated by electronic identification device 10 unless the power-on-reset function is activated. In such case, the data stored in storage means 14 may be corrupted.

The third optional function is a dual powering function for the electronic identification device. The first power source originates from the external electromagnetic field transmitted by a radio-frequency reader. This first power source is, however, only available when electronic identification device 10 is in proximity to the radio-frequency reader, i.e. in the electromagnetic field of the latter. The second, optional, source of power originates from a battery 24, advantageously the battery of the object to which the electronic identification device is applied. This second power source enables the electronic identification device to be powered when the external electromagnetic field is not present or is too far away, i.e. for example when the supply voltage extracted from the field is lower than that delivered by the second power source. Switching between the power sources is automatic and in no way alters the operation of the electronic identification device. Of course, electronic identification device 10 is capable of operating with only one of these two power sources, either that obtained by extraction from the external electromagnetic field, or that originating from a battery 24.

The electronic identification device is controlled by logic unit 20 which enables all of the functions of electronic identification device 10 to be executed by means of pre-programmed programming sequences.

A clock extractor 26 enables a clock signal to be obtained for clocking logic unit 20 of the device. The clock signal is extracted from the external electromagnetic field transmitted by a radio-frequency reader. The signal obtained at the output of the clock extractor 26 is preferably connected to a “prescaler” (not shown in the Figure), which defines the required clocking of electronic identification device 10.

A modulation circuit 28 has the function of modulating the maintained wave type RF signal from the reader, by modifying the quality factor Q of the tuning circuit (not shown in the Figure), by means of an additional resistive load parallel connected with the resonance capacitance C_{R}. These quality factor modifications induce a corresponding signal in the reader coil.

Communications from the reader to the electronic identification circuit 10 are made via all or nothing type amplitude modulation, i.e. with an index of 100% of the electromagnetic field. An amplitude demodulation circuit 30 integrated in the electronic identification device is achieved by using a simple latch. Other types of modulation could of course be used, like for example, amplitude modulation with an index less than 100% or frequency modulation.

Programmable storage means 14, preferably non-volatile means, like for example an EEPROM (Electrically Erasable Programmable Read Only Memory), are used for storing the application data comprising the various universal identifiers (UID), manufacturer identifiers (MUID) or object type or nature identifiers (DEVICE_ID), and the locking bits and user data.

A series interface 32 is made up of two lines. A first input line SCK for receiving clock signals and a second input/output line SIN/SOUT used for data transmission, to allow communication between the electronic identification device and a microcontroller of the object to which it is applied.

A limiter 34 is also provided for protecting electronic identification device 10 against stresses due to voltage surges that can occur when the electromagnetic field is too strong.

The dialogue between the reader and electronic identification devices 10 of the same type as that shown in FIG. 3, several of them being able to be present in the reader's field at the same time, occurs in accordance with the following consecutive operations:
activation of the electronic identification device when it enters the reader's electromagnetic field;
the electronic identification device waits in silent mode for a command from the reader;
transmission of a command by the reader comprising the object nature or type identifier (DEVICE_ID);
transmission of a response from the electronic identification device whose object identifier corresponds to that included in the command.

FIG. 4 shows a diagram of one implementation mode of the simplified anti-collision method between the various electronic identification devices forming a set.

The anti-collision method is applied to a determined assortment of objects of different natures or types, regrouped in the form of a set. Thus, the set includes one object of each type or nature to each of which an electronic identification device (ID1, ID2 and ID3) has been applied, comprising programmable storage means into which an object identifier (DEVICE_ID1, DEVICE_ID2, DEVICE_ID3) has been programmed, different for each nature of type of object of the set. In fact, the purpose of this object identifier (DEVICE_ID1) is to identify the nature or type of the object to which the electronic identification device has been applied. This object identifier is identical to those of objects of the same nature or type placed in other sets.

After regrouping said objects to form said set, each of the electronic identification devices (ID1, ID2, ID3) forming the set is selectively addressed by means of the object identifiers (DEVICE_ID1, DEVICE_ID2, DEVICE_ID3) of each of said objects, which are known by the reader in advance.

If no response (NO) is received for one of the addressing commands sent by the reader, this means that the electronic identification device applied to the object of the set belonging to the type of object addressed, is not present in the reader's field at that moment. The reader thus deduces that the set concerned is not complete.

Otherwise, for each addressing command sent by the reader, selectively, each electronic identification device applied to the object of the set whose object type corresponds to that addressed, sends a response (YES), thus assuring the reader of the presence of the corresponding object.

These selective addressing and response operations of the addressed electronic identification devices are carried out while the reader has not received all of the expected responses (NOT-ALL). These operations can be interrupted as soon as one of the objects addressed via the object identifier does not respond (NO). When all of the electronic identification devices have responded (ALL), the reader is assured that the set is complete.

If we consider the example of a set formed by three objects comprising a computer mouse, a keyboard and a receiver each provided with an electronic identification device (ID1, ID2 and ID3) into which an object identifier is programmed (DEVICE_ID1, DEVICE_ID2 and DEVICE_ID1), the reader will address one of the three objects by means of the corresponding object identifier (DEVICE_ID1), for example the computer mouse, which, if it is present in the reader's field, will response (YES) via the electronic identification device (ID1) with which it is fitted. The reader will then address another of the three objects by means of its object identifier (DEVICE_ID2), for example the keyboard, which, if it is present in the reader's field, will respond (YES) via its electronic identification device (ID2). The reader will then address the last of the three objects by means of its object identifier (DEVICE_ID3), in this example, the receiver, which, if it is present in the reader's field will respond (YES) via its electronic identification device (ID3). If the three objects have responded (YES), the reader is thus assured that the set is complete. Conversely, if one of the three objects has not responded (NO), then the reader is informed that the set is not complete.

This simplified anti-collision method proves very quick, because each object of the set is addressed by means of an object identifier that is known in advance, the object identifier being identical for all of the objects of the same type or nature. Thus, in order to ensure that the set is complete, one need only carry out a number of addressing operations equal to the number of objects in the set.

The invention also concerns a method of managing and/or following up the manufacturing and packaging process. During, or after, manufacture of the objects forming a set, an electronic identification device is applied to each of the objects. The storage means of each of the electronic identification devices already include the universal identifier (UID). The manufacturer of the objects, who generally affixes the electronic identification devices, preferably programmes the manufacturer identifier (MUID) in the storage means.

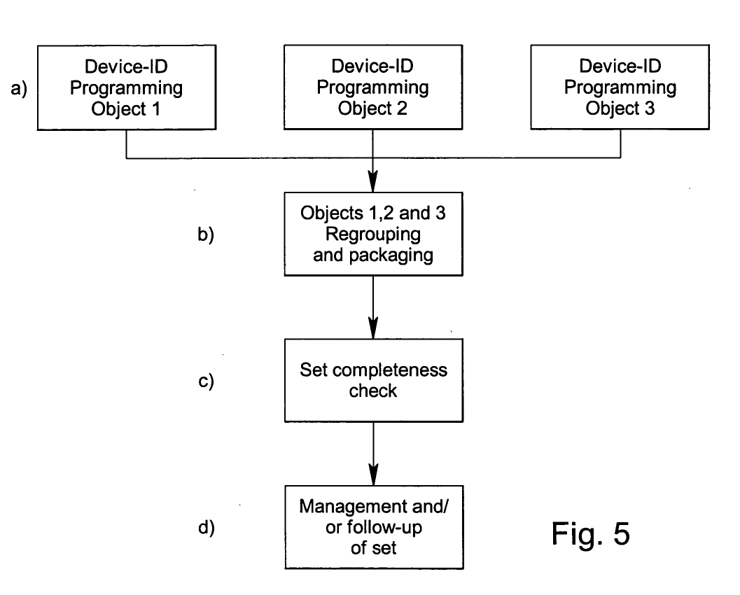

The packaging management and/or follow up method is shown in FIG. 5 in the form of a diagram showing the steps after the objects are manufactured and an electronic identification device has been affixed to each of them, the storage means thereof already including the universal identifier (UID) and the manufacturer identifier (MUID).

The first step (a) consists in programming an object identifier (DEVICE_ID1) on each object. This object identifier identifies the nature or type of the object to which the electronic identification device is applied and is identical for all of the objects of the same nature or same type. This first step (a) is advantageously carried out either after application of the electronic identification devices by the manufacturer of the objects in question, or after the regrouping thereof, but can also be carried out at any time between manufacture and packaging thereof.

The second step (b) consists in regrouping and packaging the various objects so as to form sets. In the aforementioned example, the set regroups a computer mouse, a keyboard and a receiver.

Once the sets have been formed, the third step (c) consists in checking the completeness of the sets. This step corresponds to the steps described in relation to FIG. 4 and thus they will not be described in detail here again.

A fourth optional step (d) consists in programming a management and/or follow-up value for said set into the storage means of each electronic identification device corresponding to the object addressed.

According to a particular application, the various objects are communicating electronic devices communicating with each other via a wireless communication interface.

According to this particular application, optional step (d) consists in programming a set identifier (PACKAGE_ID), which identifies said set among other sets. The set identifier (PACKAGE_ID) is then exploited by the communicating electronic devices, while they operate, to communicate with each other via their wireless communication interface.

According to an advantageous variant of this particular application, optional step (d) consists in programming a set identifier (PACKAGE_ID) which ensures a “match” of the various communicating electronic devices for their communication via the wireless communication interface. It will be noted that during this step (d) of programming the set identifier (PACKAGE_ID), the electronic communication devices are silent and that each electronic identification device is selectively activated by transmission of an activation command including the object identifier (DEVICE_ID) of the object concerned.

It will also be noted that the communicating electronic devices are preferably chosen from among wireless computer peripheral units selected from the group comprising a computer keyboard, a computer mouse, a “trackball”, a “track-pad”, a handle or game controller, a “joystick”, a video camera, a portable telephone, a personal digital assistant (PDA), a radio-frequency receiver and combinations of these communicating electronic devices.

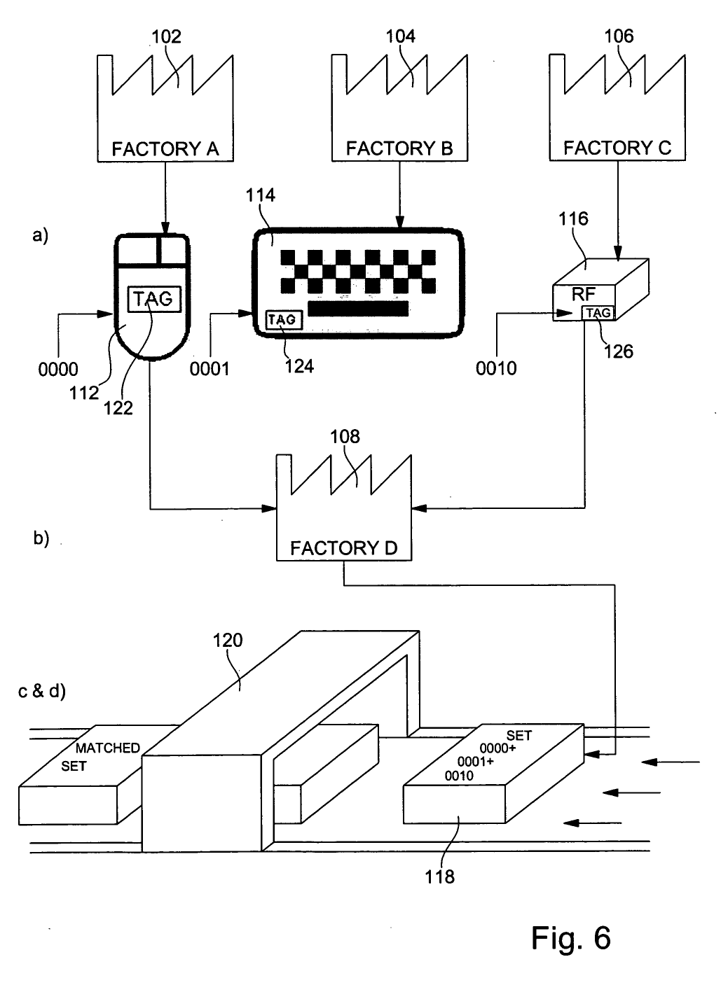

FIG. 6 shows the steps for implementing the manufacture and packaging process management and/or follow up method according to a preferred application of the invention.

According to this preferred application, the determined assortment is formed of a computer mouse 112, a keyboard 114 and a receiver 116 forming, after regrouping, a set 118. These three objects are communicating electronic devices communicating with each other via a preferably wireless communication interface.

It will be noted here that each of these object types can be manufactured at different manufacturing locations 102, 104 and 106, shown here in the form of three factories A, B and C. In the example shown, factories A, B and C respectively manufacture computer mice 112, keyboards 114 and radio-frequency receivers 116.

An electronic identification device, respectively bearing the reference numerals 122, 124 and 126 are applied to each of these different types of objects. As already mentioned, the first step (a) consists in programming an object identifier “0000 ”, “0001” and “0010” to identify each type of object in relation to other types of objects forming set 118.

Then, during a second step (b), the various objects are regrouped and packaged in the form of sets which will be subjected to the simplified anti-collision method, for example in a fourth location 108, shown here in the form of a fourth factory D.

Once the objects have been regrouped in the form of a set 118 containing one object of each type, i.e. one computer mouse, one keyboard and one receiver, a third step (c) consists in selectively addressing each of objects 112, 114 and 116 forming a set 118, by means of their respective object identifiers “0000 ”, “0001” and “0010”, which allows the completeness of each set to be checked by passing each set 118 through the electromagnetic field of an external reader 120. A fourth optional step (d) consists, during this same passage into the electromagnetic field of the external reader, in programming a set identifier (PACKAGE_ID) which ensures a “match” of the various communicating electronic devices for their communication via the wireless communication interface.

It will be understood that various modifications and/or improvements evident to those skilled in the art can be made to the various implementations of the methods according to the invention described here without departing from the scope of the invention defined by the annexed claims.

1. A simplified anti-collision method, wherein it is applied to a determined assortment of objects of different natures or types, regrouped in the form of a set, each of said objects forming the set being provided with an electronic identification device comprising programmable storage means into which there has been programmed a first identifier, or object identifier, which identifies the nature or type of the object to which the electronic identification is applied, the method including, after regrouping said objects to form said set, the following additional steps:
selectively addressing each of said objects forming said set by means of the object identifiers of each of said objects forming the determined assortment.

2. The method according to claim 1, wherein the following additional step is provided:
checking the completeness of the set consisting in checking the reception of a response from each object addressed.

3. The method according to claim 2, wherein the following step is also provided:
programming a management and/or follow up value of said set into said storage means of each electronic identification device corresponding to the object addressed.

4. The method according to claim 3, wherein the programmed management and/or follow up value is a second identifier, or set identifier, which identifies said set from among other sets.

5. The method according to claim 4, wherein said objects are communicating electronic objects communicating with each other via a wireless communication interface and wherein said set identifier is to be exploited by the communicating electronic devices, during operation, for communicating with each other via said wireless communication interface.

6. The method according to claim 4, wherein said objects are communicating electronic objects communicating with each other via a wireless communication interface and wherein said step of programming the set identifier ensures a “match” of the various communicating electronic devices for their communication via the wireless communication interface.

7. The method according to claim 6, wherein, during said step of programming the set identifier, said electronic identification devices are silent and wherein each electronic identification device is selectively activated by transmission of an activation command including the object identifier of the object concerned.

8. The method according to claim 5, wherein said communicating electronic devices are wireless computer peripheral units selected from the group including a computer keyboard, a computer mouse, a “trackball”, a “track-pad”, a handle or game controller, a “joystick”, a video camera, a portable telephone, a personal digital assistant, a radio-frequency receiver and combinations of these communicating electronic devices.

9. The method according to claim 1, wherein each object identifier is formed of a binary word with N bits, preferably greater than or equal to 3, allowing identification of 2^{N} objects of distinct types and natures.

10. A method of managing and/or following up the manufacturing and packaging process of objects of different types or natures, said objects being intended to be packaged and distributed in the form of a set regrouping a determined assortment of said objects, each of said objects being fitted with an electronic identification device including programmable storage means, wherein the method includes the following steps:
programming, in the storage means of each electronic identification device, a first identifier, or object identifier, which identifies the nature of type of the object to which the electronic identification device is applied and which is identical to the objects of the same nature or same type placed in other sets.

11. The method according to claim 10, wherein after programming said object identifiers, the following steps are provided:
regrouping and packaging said objects to form said set, and
selectively addressing each of said objects forming said set by means of the object identifiers of each of said objects forming the determined assortment.
